(19) United States
(12) Patent Application Publication
(10) Pub. No.: US 2020/0150680 A1
(43) Pub. Date: May 14, 2020

(54) OPERATION SUPPORT APPARATUS, METHOD OF SUPPORTING OPERATION, AND COMPUTER READABLE RECORDING MEDIUM

(71) Applicant: TOYOTA JIDOSHA KABUSHIKI KAISHA, Toyota-shi (JP)

(72) Inventor: Eiichi MAEDA, Nagoya-shi (JP)

(73) Assignee: TOYOTA JIDOSHA KABUSHIKI KAISHA, Toyota-shi (JP)

(21) Appl. No.: 16/566,956

(22) Filed: Sep. 11, 2019

(30) Foreign Application Priority Data
Nov. 9, 2018 (JP) 2018-211761

(51) Int. Cl. G05D 1/02; G05D 1/00

(52) U.S. Cl. CPC G05D 1/0276; G05D 1/0088

(57) ABSTRACT

An operation support apparatus for supporting an operation to be performed on a vehicle includes a processor configured to: obtain first operation information relating to an operation performed by a user in a first vehicle; generate, from the first operation information, second operation information for performing an operation equivalent to the operation in a second vehicle that is different from the first vehicle; and output the second operation information.

The present application claims priority to and incorporates by reference the entire contents of Japanese Patent Application No. 2018-211761 filed in Japan on Nov. 9, 2018.

### BACKGROUND

The present disclosure relates to an operation support apparatus, a method of supporting an operation, and a computer readable recording medium.

In the related art, there has been proposed a technique for an on-vehicle information terminal that efficiently collects information relating to the use states of functions that the on-vehicle information terminal has without making a driver aware. For example, JP 2009-250811 A discloses an on-vehicle information terminal that includes a use state obtainment unit that obtains information relating to a state of the use of each function made by a driver, and a use state report unit that reports the information obtained by the use state obtainment unit to a data collection server at a predetermined timing, and that provides a plurality of functions to a driver of a vehicle.

However, in different vehicles, for example, positions of an input unit operated by a user and operation methods such as operation procedures when setting a traveling mode or the like by using the input unit are often different from each other. Therefore, in a case where a vehicle that a user gets in is changed from a first predetermined vehicle to another second vehicle, there is a problem in which it takes time for the user to get used to a position and an operation method of an input unit in the second vehicle.

There is a need for an operation support apparatus, a method of supporting an operation, and a computer readable recording medium that enable a user to smoothly operate an input unit in a second vehicle even in a case where the user has changed a vehicle to be gotten in from the first vehicle to the second vehicle.

### SUMMARY

According to an exemplary embodiment of the present disclosure, there is provided an operation support apparatus for supporting an operation to be performed on a vehicle, the operation support apparatus including a processor configured to: obtain first operation information relating to an operation performed by a user in a first vehicle; generate, from the first operation information, second operation information for performing an operation equivalent to the operation in a second vehicle that is different from the first vehicle; and output the second operation information.

The above and other objects, features, advantages and technical and industrial significance of this disclosure will be better understood by reading the following detailed description of exemplary embodiments of the disclosure, when considered in connection with the accompanying drawings.

### BRIEF DESCRIPTION OF THE DRAWINGS

FIG. 1 is a schematic diagram illustrating an operation support system to which an operation support apparatus according to an exemplary embodiment may be applied;

FIG. 2 is a block diagram schematically illustrating a configuration of a server of the operation support system illustrated in FIG. 1;

FIG. 3 is a block diagram schematically illustrating a configuration of a vehicle of the operation support system illustrated in FIG. 1;

FIG. 4 is a block diagram schematically illustrating a configuration of a terminal device of the operation support system illustrated in FIG. 1;

FIG. 5 is a flowchart for explaining a method for storing operation information in an operation support method according to the exemplary embodiment;

FIG. 6 is a diagram illustrating a travelling mode selection switch for explaining an example according to the exemplary embodiment;

FIG. 7 is a flowchart for explaining the operation support method according to the exemplary embodiment;

FIG. 8A is a diagram illustrating a steering switch for explaining an example according to the exemplary embodiment;

FIG. 8B is a diagram illustrating an information displaying display for explaining an example according to the exemplary embodiment; and

FIG. 9 is a block diagram schematically illustrating a configuration of a vehicle in an operation support system according to an exemplary embodiment.

### DETAILED DESCRIPTION

Exemplary embodiments are described below with reference to the drawings. Note that in all of the drawings of the exemplary embodiments described below, the same or corresponding parts are denoted by the same reference numerals. Further, the present disclosure is not limited to the exemplary embodiments described below.

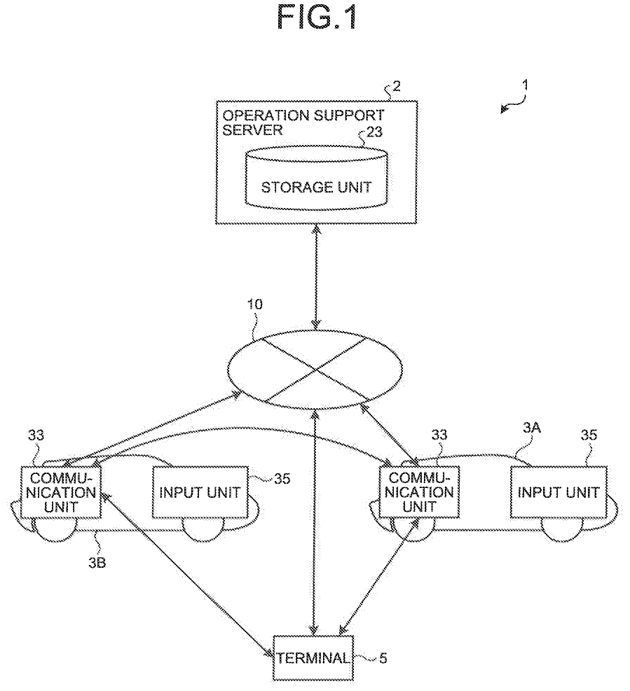

First, an operation support system to which an operation support apparatus may be applied is described. FIG. 1 is a schematic diagram illustrating the operation support system to which the operation support apparatus may be applied. As illustrated in FIG. 1, an operation support system 1 includes an operation support server 2, vehicles 3A and 3B each including a communication unit 33 and an input unit 35, and a user terminal device 5 that are mutually communicable via a communication network 10.

The communication network 10 includes an Internet line network, a mobile phone line network, or the like. The communication network 10 is, for example, a public communication network such as the Internet, and is configured by one or more combinations of, for example, a local area network (LAN), a wide area network (WAN), a telephone communication network of a mobile phone or the like or a public line, a virtual private network (VPN), a dedicated line, and the like. In the communication network 10, wired communication and wireless communication are appropriately combined.

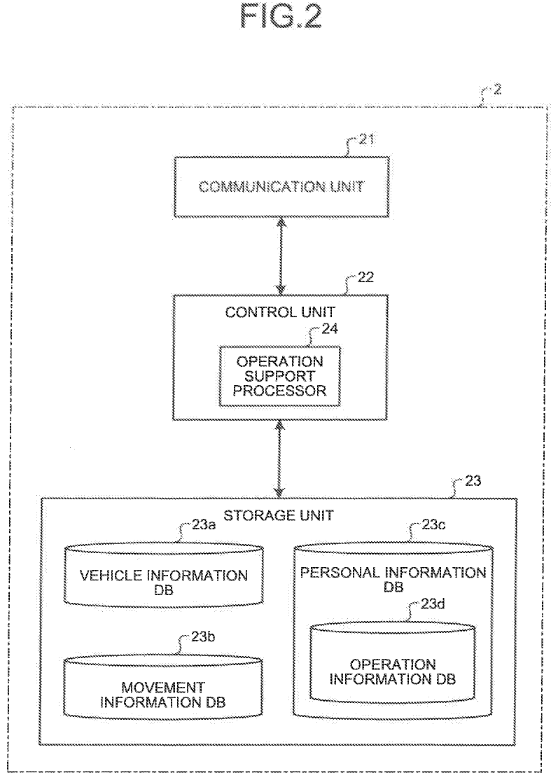

The operation support server 2 serving as an operation support apparatus transmits or receives various types of information to or from the vehicle 3A or 3B (hereinafter referred to as a vehicle 3 in a case where the vehicles 3A and 3B are collectively referred to or in a case where distinction is not required) or the user terminal device 5. The operation support server 2 and the vehicle 3 transmit or receive information relating to an operation of an input operation unit that configures the input unit 35 in the vehicle 3 (hereinafter referred to as operation information). The operation information includes information relating to a position and an operation procedure of the input operation unit of the input unit 35 of the vehicle 3 (hereinafter also referred to as operation procedure information). FIG. 2 is a block diagram schematically illustrating a configuration of the operation support server 2. As illustrated in FIG. 2, the operation support server 2 has a configuration of a general computer that is communicable via the communication network 10. The operation support server 2 includes a communication unit 21, a control unit 22, and a storage unit 23.

The communication unit 21 serving as an information obtainment unit transmits or receives the operation information to or from the vehicle 3. The communication unit 21 transmits, to the user terminal device 5, various types of information for using the vehicle 3 to a user terminal device 5 possessed by a user in the use of the vehicle 3, or receives, from the user terminal device 5, various types of information, such as user identification information or user personal information, for identifying the user.

The control unit 22 specifically includes a processor such as a central processing unit (CPU), a digital signal processor (DSP), or a field-programmable gate array (FPGA), and a main storage unit such as a random access memory (RAM) or a read only memory (ROM) (both the processor and the main storage unit are not illustrated). The control unit 22 loads a program stored in the storage unit 23 into a work area of the main storage unit, executes the program, and controls each component and the like through the execution of the program. Thus, the control unit 22 may realize a function of an operation support processor 24 that meets a predetermined purpose.

The storage unit 23 physically includes a storage medium selected from a volatile memory such as a RAM, a non-volatile memory such as a ROM, an erasable programmable ROM (EPROM), a hard disk drive (HDD), a removable medium, and the like. The storage unit 23 includes a storage medium selected from the hard disk drive (HDD), the removable medium, and the like. The removable medium is, for example, a universal serial bus (USB) memory, or a disc recording medium such as a compact disc (CD), a digital versatile disc (DVD), or a Blu-ray (registered trademark) disc (BD). In addition, the storage unit 23 may be configured using a computer-readable recording medium, such as a memory card, that may be externally mounted. The storage unit 23 may store an operating system (OS), various programs, various tables, various databases, and the like for performing an operation of the operation support server 2. The various programs also include a model update processing program. These various programs may also be distributed widely by being recorded in a computer-readable recording medium such as a hard disk, a flash memory, a CD-ROM, a DVD-ROM, or a flexible disk.

The storage unit 23 includes a vehicle information database 23a, a movement information database 23b, a personal information database 23c, and an operation information database 23d, each of which is configured, for example, by a relational database (RDB). The operation information database 23d configures a portion of the personal information database 23c. Note that a program of a database management system (DBMS) executed by the processor described above manages data stored in the storage unit, so that each database (DB) described below is constructed.

In the vehicle information database 23a, various types of vehicle information including a battery charge amount, a remaining amount of fuel, a current position, and the like that have been transmitted from each of the vehicles 3 are stored so as to be updatable. In the movement information database 23b, traveling history information including a traveling route, speed, acceleration, and the like of each of the vehicles 3 and information relating to the movement of the vehicle 3 (hereinafter referred to as movement information), such as information relating to a traveling state, are stored so as to be updatable.

In the personal information database 23c, user terminal identification information, user's own personal information (hereinafter referred to as user personal information) including the user's operation information, and the like are associated with each other, and are stored in a searchable manner. Herein, “personal information” is information relating to an individual, and is information that may identify a specified individual by using a name, a date of birth, and other information that are included in the information. The “personal information” includes information that may be easily collated with other information so as to be able to identify a specified individual. When a user operates an input operation unit of the input unit 35 in the vehicle 3, operation information relating to the input operation unit operated by the user is stored in the operation information database 23d. The operation information is included in the user personal information. The user personal information may include various types of information that the user has input or selected by using the user terminal device 5 (hereinafter referred to as user selection information).

The user selection information may include information relating to an item selected by each of the users, information relating to the user's driving of the vehicle 3, and the like.

The operation support processor 24 obtains the operation information transmitted from the vehicle 3 through the communication unit 21, and stores the operation information in the operation information database 23d of the storage unit 23. In a case where the user terminal device 5 is caused to store the operation information, the operation information is transmitted from the user terminal device 5 to the operation support server 2. The operation support processor 24 performs processing for generating second operation information of the vehicle 3B serving as a second vehicle from first operation information of the vehicle 3A serving as a first vehicle on the basis of the received operation information. Here, processing for generating the second operation information from the first operation information refers to processing for generating second operation information from first operation information, the first operation information including operation procedure information of the input unit 35 that may produce a predetermined result, such as a motion or a change in a state of the vehicle 3A, that is realized by the user operating the input unit 35 in the vehicle 3A, the second operation information including operation procedure information of the input unit 35 that may produce, in the vehicle 3B, an operation equivalent to the operation in the vehicle 3A, in other words, substantially the same result as the predetermined result. The input unit 35 includes an input group 350 including a plurality of input operation units, each of which includes an operation switch, an operation button, and the like. The operation procedure information includes information relating to an arrangement position and information relating to an operation method of the input operation unit in the input group 350 for obtaining a predetermined result in the vehicle 3. The operation support processor 24 stores the first operation information and the generated second operation information in the operation information database 23d.

The user terminal identification information is stored in the personal information database 23c in a searchable state after being assigned to the user terminal device 5. The user terminal identification information includes various types of information for distinguishing respective user terminal devices 5 from each other. The user terminal identification information is, for example, individual identification information, such as a terminal ID, a MAC address, or a manufacturing number, that enables each of the user terminal devices 5 to be identified, but if individual user terminal devices 5 may be distinguished from each other, another type of information may be used. The user terminal identification information includes information necessary for accessing the operation support server 2 when information relating to the user terminal device 5 is transmitted or received, and is registered in association with the user personal information. Specifically, when the user terminal device 5 transmits, to the operation support server 2, predetermined information such as the user personal information, together with the user terminal identification information, the operation support server 2 stores the user personal information including the operation information in association with the user terminal identification information in a searchable state in the personal information database 23c of the storage unit 23.

The vehicle identification information is stored in the vehicle information database 23a in a searchable state after being assigned to the vehicle 3. The vehicle identification information includes various types of information for distinguishing individual vehicles 3 from each other. When the vehicle 3 transmits the vehicle information together with the vehicle identification information to the operation support server 2, the control unit 22 stores the vehicle information in association with the vehicle identification information in a searchable state in the vehicle information database 23a. Similarly, when the vehicle 3 transmits the movement information to the operation support server 2, the control unit 22 stores the movement information in association with the vehicle identification information in a searchable state in the movement information database 23b.

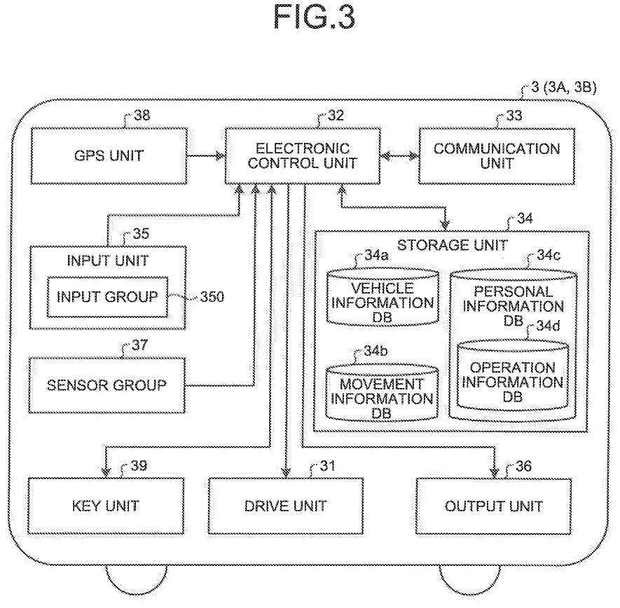

The vehicle 3 is a vehicle that travels by being driven by a user, or an autonomous traveling vehicle that is configured to be capable of autonomous traveling according to a given movement command. FIG. 3 is a block diagram schematically illustrating a configuration of the vehicle 3. As illustrated in FIG. 3, the vehicle 3 includes a drive unit 31, an electronic control unit 32, the communication unit 33, a storage unit 34, the input unit 35 that is provided with the input group 350 including at least one input operation unit, an output unit 36, a sensor group 37, a GPS unit 38, and a key unit 39.

The drive unit 31 is a conventionally known drive unit necessary for the traveling of the vehicle 3. Specifically, the vehicle 3 includes an engine serving as a drive source, the engine generates power by using a motor or the like according to driving due to combustion of fuel, and the generated power is charged in a chargeable battery. The vehicle 3 further includes a drive transmission mechanism that transmits a driving force of the engine, drive wheels for traveling, and the like.

The electronic control unit 32 and the storage unit 34 are physically similar to the control unit 22 and the storage unit 23 described above, respectively. The electronic control unit 32 centrally controls operations of various components mounted on the vehicle 3. The communication unit 33 performs wireless communication via the communication network 10 so as to perform communication with the operation support server 2, with the communication unit 33 of another vehicle 3, and with the user terminal device 5. The communication unit 33 may be further enabled to perform direct communication with the communication unit 33 of another vehicle 3 or the user terminal device 5. Stated another way, for example, inter-vehicle communication may be enabled between the vehicle 3A and the vehicle 3B, or short-range wireless communication may be enabled between the vehicle 3 and the user terminal device 5.

The storage unit 34 includes a vehicle information database 34a, a movement information database 34b, and a personal information database 34c including an operation information database 34d. In the vehicle information database 34a, various types of information relating to a state of the vehicle 3, such as a battery charge amount, a remaining amount of fuel, or a current position for example, are stored so as to be updateable. In the movement information database 34b, various types of movement information relating to the movement of the vehicle 3 including the traveling history information of the vehicle 3 and various types of movement information transmitted from another server (not illustrated) are stored so as to be updateable. In the personal information database 34c, the user terminal identification information is mutually associated with the user personal information, the user selection information, or the like, and is stored in a searchable manner. Operation information relating to an input operation unit operated by a user in the vehicle 3 is stored in the operation information database 34d.

The input unit 35 includes the input group 350 that is configured to include a plurality of input operation units such as a touch panel display, a speaker microphone, an operation button, or a toggle, for example. The input unit 35 is configured to be able to input predetermined information to the electronic control unit 32 by a user or the like operating the operation button or the toggle serving as the input operation unit or emitting sound toward the speaker microphone. The output unit 36 serving as a report unit is configured to be able to report predetermined information to the outside by displaying characters, figures, or the like on a screen of the touch panel display or outputting sound from the speaker microphone according to the control of the electronic control unit 32.

The sensor group 37 includes a sensor relating to traveling of the vehicle 3, such as a vehicle speed sensor or an acceleration sensor, a vehicle interior sensor that is capable of detecting, for example, various situations in a vehicle interior, an imaging device such as an imaging camera, and the like. The GPS unit 38 serving as a position information obtainment unit of the vehicle 3 receives radio waves from a global positioning system (GPS) satellite (not illustrated), and detects a position of the vehicle 3. The detected position of the vehicle 3 is stored as position information in the vehicle information in a searchable manner in the vehicle information database 34a. Note that, as a method for detecting the position of the vehicle 3, a method obtained by combining light detection and ranging or laser imaging detection and ranging (LiDAR) with a three-dimensional digital map may be employed. A key unit 58 is configured to be able to perform locking or unlocking of the vehicle 3 by performing authentication based on, for example, BLE authentication information with the user terminal device 5.

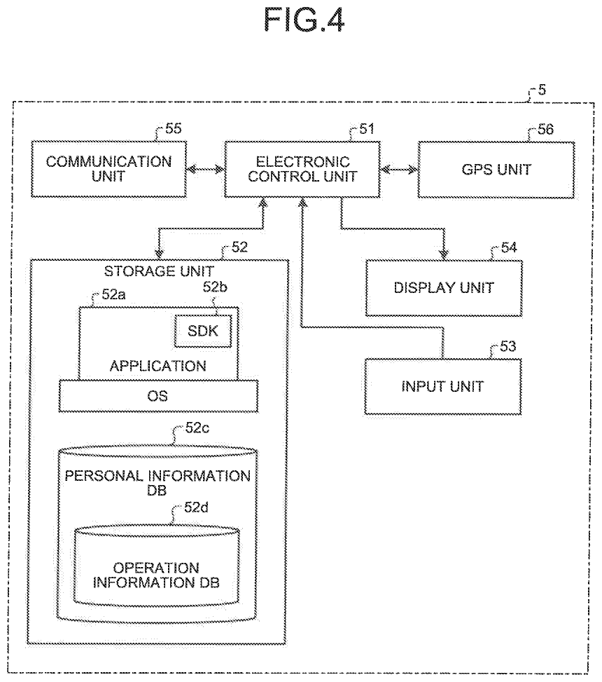

The user terminal device 5 serving as a terminal is operated by a user. The user terminal device 5 transmits, to the operation support server 2, various types of information, such as the user identification information, the user selection information, or the user personal information including the operation information, for example, via call using various types of data or sound by using a communication application. The user terminal device 5 is configured to be able to receive various types of information, such as the operation information including the operation procedure information, from the operation support server 2. FIG. 4 is a block diagram schematically illustrating a configuration of the user terminal device 5 illustrated in FIG. 1.

As illustrated in FIG. 4, the user terminal device 5 includes an electronic control unit 51, a storage unit 52, an input unit 53, a display unit 54, a communication unit 55, and a GPS unit 56 that are communicably connected to each other. The electronic control unit 51, the storage unit 52, and the communication unit 55 are physically similar to the control unit 22, the storage unit 23, and the communication unit 21 described above, respectively. The GPS unit 56 is physically similar to the GPS unit 38 described above.

The electronic control unit 51 may execute various programs stored in the storage unit 52, and may store various tables, various databases, and the like in the storage unit 52. The storage unit 52 may store an OS and an application 52a for performing an operation of the operation support server 2, a personal information database 52c including an operation information database 52d, and the like. The user identification information is configured to be able to be stored. A lock/unlock request program 52b is incorporated into the application 52a, for example, in the form of a software development kit (SDK).

The electronic control unit 51 loads the OS and the application 52a stored in the storage unit 52 in a work area of the main storage unit, executes the OS and the application 52a, and centrally controls operations of the storage unit 52, the input unit 53, the display unit 54, the communication unit 55, and the GPS unit 56. The lock/unlock request program 52b is executed by the application 52a of the user terminal device 5, authentication is performed between the user terminal device 5 and the key unit 39, and locking or unlocking of the vehicle 3 is performed. Note that various conventionally known methods may be employed for the locking/unlocking of the vehicle 3 that is performed via communication between the user terminal device 5 and the key unit 58.

The input unit 53 is configured, for example, by a keyboard, a touch panel keyboard that is incorporated into the inside of the display unit 54 so as to detect a touch operation on a display panel, a sound input device that enables calls with the outside, or the like. Here, the calls with the outside not only include calls with another user terminal device 5 but also include, for example, calls with an operator resident in the operation support server 2 or an artificial intelligence system, and the like. The display unit 54 is configured, for example, by an organic EL panel, a liquid crystal display panel, or the like, and reports information to the outside by displaying characters, figures, or the like on the display panel. The input unit 53 and the display unit 54 may be configured similarly to the input unit 35 described above. The communication unit 55 transmits or receives various types of information, such as the user identification information, the user selection information, sound data, or the operation information, to or from an external server such as the operation support server 2 via the communication network 10. The GPS unit 56 serving as a position information obtainment unit of a terminal performs communication with a GPS satellite (not illustrated) so as to detect a position of the user terminal device 5. The detected position is transmitted as user position information in the user identification information to the operation support server 2, a data server (not illustrated) that collects and stores big data, or the like via the communication network 10. As the user terminal device 5, specifically, various devices that may be carried by a user, such as a mobile phone, e.g., a smartphone, or an information terminal of a tablet type or the like, may be used.

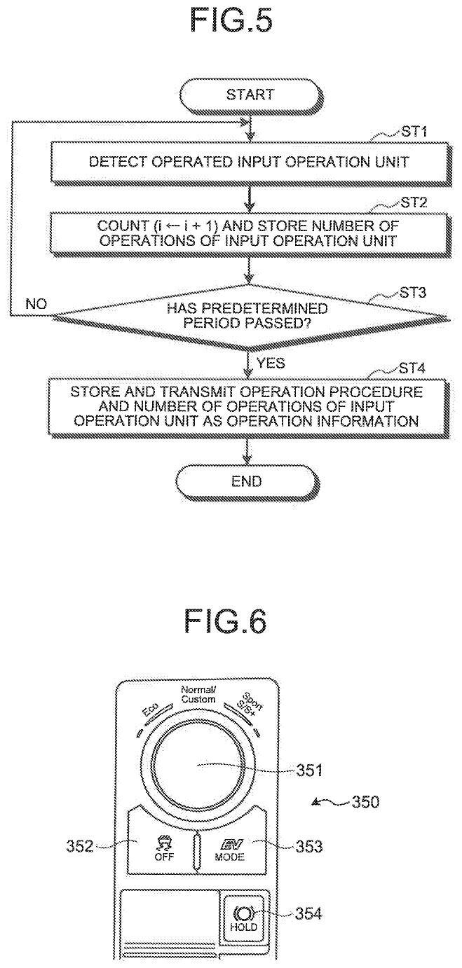

Next, an operation support method is described. In the description below, each description of transmission or reception of information that is performed via the communication network 10 is omitted. FIG. 5 is a flowchart for explaining a method for storing operation information in the operation support method. The operation support method below is described by using, as an example, a case where a user who has been in the vehicle 3A serving as the first vehicle or a user who has gotten in the vehicle 3A gets in the vehicle 3B serving as the second vehicle at the next opportunity. The flowchart illustrated in FIG. 5 is performed in the vehicle 3A. FIG. 6 is a diagram illustrating a traveling mode selection switch that is an example of the input group 350 mounted on the vehicle 3A.

As illustrated in FIG. 5, first, in step ST1, the electronic control unit 32 of the vehicle 3A detects which input operation unit of the input group 350 is being operated by the user. Specifically, for example, as illustrated in FIG. 6, the user rotates a toggle 351, presses an off button 352, or presses an EV mode button 353 in order to select a traveling mode. The toggle 351, the off button 352, and the EV mode button 353 are examples of the input operation unit. The electronic control unit 32 of the vehicle 3A detects whether at least one input operation unit configuring the input group 350 has been operated by the user, and detects which input operation unit has been operated by the user, on the basis of a signal from the operated input operation unit.

Next, the processing moves on to step ST2, and the electronic control unit 32 counts up the number of operations performed on the input operation unit on which an operation has been detected. Specifically, a counter i of the number of operations performed on the detected input operation unit is incremented by one. The number of operations expressed by the counter i is stored in association with each of the input operation units in the operation information database 34d of the vehicle 3A. Stated another way, information relating to the input operation unit and information relating to the number of operations that have been associated with each other are stored in the operation information database 34d of the vehicle 3A. Here, at a point in time at which an input operation unit operated by the user is detected and the counter i is counted up, the detected input operation unit, the counted-up number of operations, and movement information including the traveling history of the vehicle 3A may be associated with each other, and may be stored in the operation information database 34d. At this time, vehicle information of the vehicle 3A may be associated with the input operation unit, the number of operations, and the movement information including the traveling history information. Operation procedure information relating to an operation procedure performed on the input operation unit by the user may be stored in the operation information database 34d in association with the input operation unit. Rather than the method for counting the number of operations, a method for adding a time period during which an operation is performed for each of the input operation units may be employed. In this case, the number of operations described above is an operation time period.

Next, in step ST3, the electronic control unit 32 determines whether a predetermined period set in advance has passed in a process of detecting an input operation unit and a process of counting the number of operations performed on the input operation unit. The predetermined period may be set to various periods such as a period of one day or one week, a period during which the user is driving the vehicle 3A, a period of one or more drivings performed by the user, or a period during which driving time periods are accumulated up to, for example, a predetermined time period. In a case where the electronic control unit 32 determines in step ST3 that the predetermined period has not passed in the processes of steps ST1 and ST2 (step ST3: No), steps ST1 and ST2 are repeatedly performed. As a result, various input operation units and the number of operations performed on these input operation units are stored in the operation information database 34d in association with each other.

On the other hand, in a case where the electronic control unit 32 determines in step ST3 that the predetermined period has passed in the processes of steps ST1 and ST2 (step ST3: Yes), the processing moves on to step ST4. In step ST4, the electronic control unit 32 generates first operation information from operation procedure information of at least one input operation unit detected in steps ST1 and ST2 and information relating to the number of operations associated with this input operation unit, and stores the first operation information in the operation information database 34d. The electronic control unit 32 transmits the first operation information stored in the operation information database 34d to the operation support server 2. In a case where at least one of the vehicle information and the movement information is associated with the first operation information, the electronic control unit 32 also transmits the associated information to the operation support server 2. The control unit 22 of the operation support server 2 having received the first operation information stores the received first operation information in the operation information database 23d. Thus, processing for obtaining the first operation information is terminated. Note that the first operation information may be stored in a recording medium included in a key possessed by the user, another removable and portable recording medium, or the storage unit 52 of the user terminal device 5 possessed by the user.

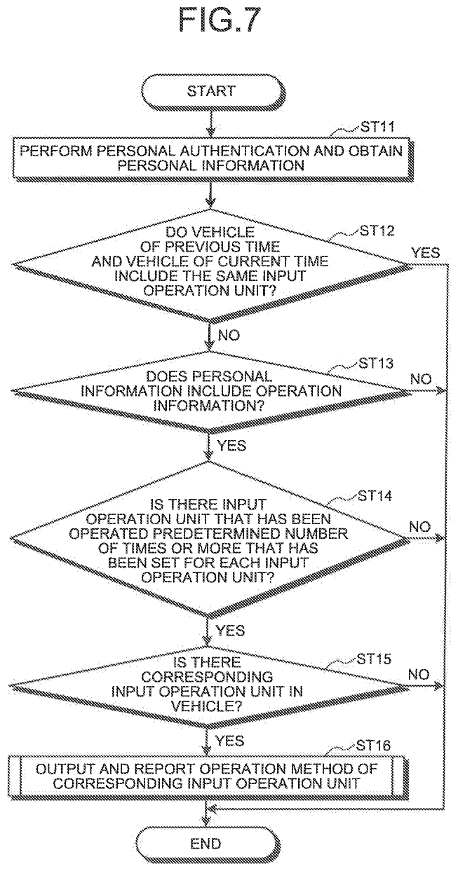

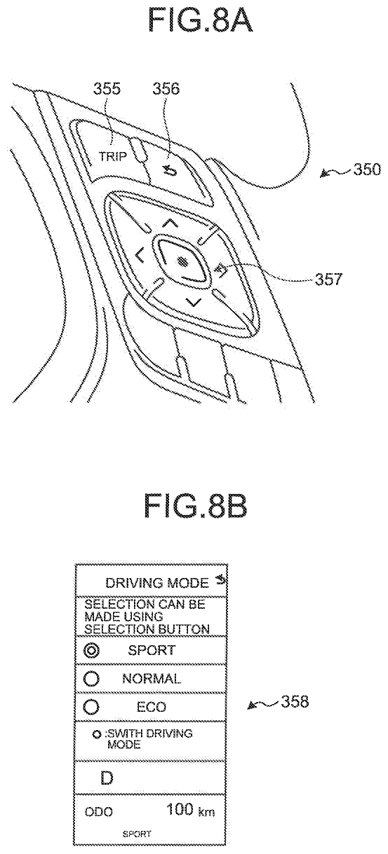

Next, operation support processing performed in the vehicle 3B is described. FIG. 7 is a flowchart for explaining an operation support method. The flowchart illustrated in FIG. 7 is principally performed in the operation support server 2. FIG. 8A is a diagram illustrating a steering switch mounted on the vehicle 3B, and FIG. 8B is a diagram illustrating an information displaying display that configures an output unit of the vehicle 3B.

First, when a user who has gotten in the vehicle 3A in the past tries to get in the other vehicle 3B at a later opportunity, the operation support processing illustrated in FIG. 7 is started. In step ST11, the electronic control unit 32 of the vehicle 3B performs a personal authentication process, so that user personal information is obtained. Specifically, first, the lock/unlock request program 52b is executed by the application 52a of a user terminal device 5 possessed by the user. By doing this, authentication is performed between the user terminal device 5 and the key unit 39 of the vehicle 3B, and the vehicle 3B is unlocked. When the personal authentication process is performed, the electronic control unit 32 of the vehicle 3B transmits a request signal for vehicle information, movement information, user terminal identification information, and user personal information to the operation support server 2 via the communication unit 33.

The personal authentication process may be performed according to various conventionally known methods. For example, the user terminal identification information may be transmitted from the user terminal device 5 to the operation support server 2, the user personal information may be retrieved from the personal information database 23c of the storage unit 23 on the basis of the user terminal identification information received by the control unit 22, the personal authentication process may be performed, and a result may be transmitted to the vehicle 3B.

The operation support processor 24 of the operation support server 2 retrieves user personal information of the user who gets in the vehicle 3B from the personal information database 23c on the basis of the received user terminal identification information and the personal information stored in the personal information database 23c, and transmits the user personal information to the vehicle 3B. By doing this, the vehicle 3B obtains user personal information of a user who gets in the vehicle 3B.

Note that another method may be employed as a method in which the vehicle 3B obtains the user personal information. Specifically, in a case where the user personal information is stored in a rewritable recording medium that is provided in a key or that is portable, the key or the recording medium may be connected to a predetermined portion of the vehicle 3B that enables information to be read, and the user personal information may be supplied to the electronic control unit 32 of the vehicle 3B. Here, as the recording medium, various rewritable recording media such as a USB memory or an SD memory card may be employed. In addition, the user terminal device 5 and the vehicle 3B may be caused to perform communication by using a short-range wireless communication technology such as Bluetooth (registered trademark) or near field communication (NFC), and information, such as user personal information, that is stored in the user terminal device 5 may be transmitted to the vehicle 3B. Further, the user personal information may be transmitted from the communication unit 33 of the vehicle 3A serving as a first communication unit to the communication unit 33 of the vehicle 3B serving as a second communication unit through inter-vehicle communication.

Next, the processing moves on to step ST12, and the operation support processor 24 determines whether the vehicle 3A and the vehicle 3B include the same input group 350 on the basis of operation information that is included in the user personal information and that relates to an input group 350 of a vehicle that the user has gotten in previous time, in this example, the vehicle 3A, and operation information that relates to the input group 350 of the vehicle 3B. Note that information relating to input groups 350 in all types of vehicles may be stored in advance in the vehicle information database 23a of the operation support server 2, and respective pieces of information relating to the input groups 350 of the vehicles 3A and 3B may be retrieved from the vehicle information database 23a, and a comparison may be performed. Here, respective input groups 350 being the same as each other means that the respective vehicles 3A and 3B to be compared have the same arrangement and the same operation method of a plurality of input operation units that configure the respective input groups 350.

In a case where the operation support processor 24 determines in step ST12 that the vehicles 3A and 3B include the same input group 350 (step ST12: Yes), the operation support processing is terminated. On the other hand, in a case where the operation support processor 24 determines that the vehicles 3A and 3B include input groups 350 different from each other (step ST12: No), the processing moves on to step ST13. In step ST12, the vehicle 3A to be compared with the vehicle 3B may be a vehicle that has been selected from vehicles that are included in user personal information and that a user has gotten in in the past in accordance with a predetermined method or rule, rather than a vehicle that the user has gotten in previous time. In addition, step ST12 may be performed at any timing during steps ST13 to ST16 described later.

The processing moves on to step ST13, and the operation support processor 24 determines whether the received user personal information includes operation information. In a case where the operation support processor 24 determines that the user personal information does not include the operation information (step ST13: No), the operation support processing is terminated. On the other hand, in a case where the operation support processor 24 determines that the user personal information includes the operation information (step ST13: Yes), the processing moves on to step ST14.

In step ST14, the operation support processor 24 determines whether there is an input operation unit that has been operated a predetermined number of times or more that has been set for each of the input operation units (hereinafter referred to as a predetermined input operation unit) from among input operation units operated by the user in the vehicle 3A included in the operation information. In a case where the operation support processor 24 determines that there are no predetermined input operation units (step ST14: No), the operation support processing is terminated. In a case where the operation support processor 24 determines that there is the predetermined input operation unit (step ST14: Yes), the processing moves on to step ST15.

In step ST15, the operation support processor 24 determines whether there is an input operation unit that has substantially the same function as a function of the predetermined input operation unit (hereinafter referred to as a corresponding input operation unit) in the vehicle 3B that the user has gotten in. In a case where the operation support processor 24 determines that there are no corresponding input operation units in the vehicle 3B (step ST15: No), the operation support processing is terminated. In a case where the operation support processor 24 determines that there is the corresponding input operation unit in the vehicle 3B (step ST15: Yes), the processing moves on to step ST16.

In step ST16, the operation support processor 24 generates and outputs operation information of the vehicle 3B from operation information of the vehicle 3A. Specifically, the operation support processor 24 transmits, to the vehicle 3B, operation information including operation procedure information of the corresponding input operation unit of the vehicle 3B that corresponds to the predetermined input operation unit in the vehicle 3A. The electronic control unit 32 of the vehicle 3B having received the operation information stores the received operation information in the operation information database 34d. The electronic control unit 32 reads the operation information from the operation information database 34d, and reports a specific operation method via the output unit 36 serving as a report unit.

A specific example of reporting an operation method in step ST16 of the operation support method described above is described below. In a first example, it is assumed that a report timing is a timing immediately after the start of the drive unit 31 of the vehicle 3B, for example, a timing immediately after the start of the engine, and a report method is a method that uses sound and that may be auditorily recognized by a user.

First, a user who has gotten in the vehicle 3A operates the toggle 351, the off button 352, the EV mode button 353, a hold button 354, or the like in the input group 350 provided in the vehicle 3A, as illustrated in FIG. 6, for example, in order to select a traveling mode. Input operation units of the input group 350 provided in the vehicle 3A are the predetermined input operation units described above. Operation information including an operation performed on the input group 350 by the user is transmitted to the operation support server 2 via the communication unit 33 of the vehicle 3A.

As illustrated in FIG. 8A, the input group 350 of the vehicle 3B includes a steering switch that includes a TRIP button 355, a return button 356, a select button 357, and the like that serve as input operation units. Input operation units that configure the input group 350 of the vehicle 3B are corresponding input operation units that correspond to the input operation units of the input group 350 of the vehicle 3A. When the user gets in the vehicle 3B and starts the engine of the drive unit 31, the electronic control unit 32 outputs the operation procedure information included in the operation information as sound from the speaker microphone in the output unit 36 of the vehicle 3B. In this case, the output sound is sound that guides an operation to be performed on the input operation unit of the input group 350, such as the sound “a traveling mode can be switched by using the steering switch” or the sound “when the traveling mode is switched to the eco mode, press the up button of the selector switch”. By doing this, a user who is in the vehicle 3B may perform a desired operation by using the input operation unit of the input group 350 of the vehicle 3B, even when the user drives the vehicle 3B for the first time.

In a second example, it is assumed that a report timing is a timing when a traveling state or a vehicle state of the vehicle 3B becomes close to a traveling state or a vehicle state at a time when the input group 350 has been operated in the vehicle 3A. It is also assumed that a report method in the second example is a method that uses the information displaying display of the output unit 36 and that may be visually recognized by a user.

When a user operates the input group 350 in the vehicle 3A, the operation information is stored in the operation information database 34d in association with at least one of the movement information and the vehicle information, in response to the electronic control unit 32 detecting the operation. The operation information, and the movement information or the vehicle information that has been associated with the operation information are transmitted to the operation support server 2 via the communication unit 33 of the vehicle 3A. In a case where the electronic control unit 32 of the vehicle 3B determines that the movement information or the vehicle information of the vehicle 3B that is constantly obtained becomes information close to the movement information or the vehicle information of the vehicle 3A that has been received from the operation support server 2, the electronic control unit 32 reports operation information of the vehicle 3B that corresponds to the operation information that has been associated with the movement information or the vehicle information described above.

For example, a case is assumed where the movement information associated with the operation information includes traveling history information indicating traveling on a downhill slope. In this case, when the vehicle 3B travels on a downhill slope, operation information of a corresponding input operation unit of the vehicle 3B is reported in accordance with operation procedure information of an input operation unit in the vehicle 3B that corresponds to operation procedure information of an input operation unit in the vehicle 3A. In this case, as illustrated in FIG. 8B, an operation method in the vehicle 3B is displayed on an information displaying display 358 of the output unit 36. In the example illustrated in FIG. 8B, a sentence guiding an operation to be performed on the input operation unit, such as “selection may be made using select button”, is displayed on the information displaying display 358. Note that a method for guiding an operation to be performed on an input operation unit by using turning on or blinking of light may be employed in addition to a method for displaying a sentence explaining an operation.

In a third example, it is assumed that a report timing is a timing after a user in the vehicle 3B makes an inquiry about an operation method by using sound or the steering switch. First, while a user is in the vehicle 3B, the user inputs an inquiry about an operation by sound by using, for example, the speaker microphone of the input unit 35. Sound information of the user is output from the input unit 35 to the electronic control unit 32. The electronic control unit 32 performs conventionally known sound recognition processing on the input sound information so as to convert the content of the user's inquiry into information that may be recognized by the electronic control unit 32. The electronic control unit 32 retrieves operation information stored in the operation information database 34d in response to the recognized content of the user's inquiry. The electronic control unit 32 reports an operation method on the basis of operation procedure information included in the operation information. Note that a method similar to methods in the first and second examples may be employed as a method for reporting the operation method.

The first to third examples described above may be implemented in combination with each other as appropriate.

In a case where a user who has gotten in the vehicle 3A in the past gets in the vehicle 3B next time, operation information relating to an input operation unit of the vehicle 3B that corresponds to operation information relating to the user in the vehicle 3A is reported to the user. As a result, even in a case where the user has little experience in driving the vehicle 3B or being in the vehicle 3B, the user may easily recognize an operation method of an input operation unit in the input group 350 of the vehicle 3B, and may easily grasp a position of the input operation unit or a procedure of an operation to obtain a predetermined result in the vehicle 3B.

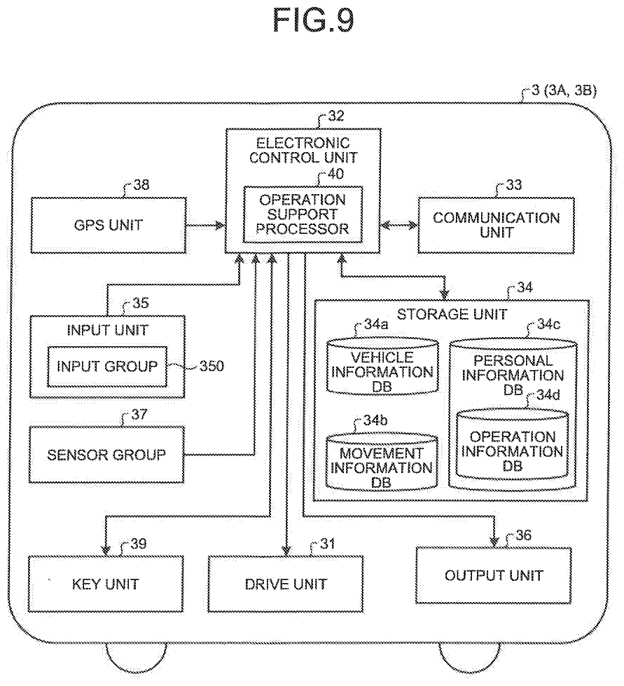

FIG. 9 is a block diagram schematically illustrating another configuration of the vehicle 3 in the operation support system 1. The configuration of the vehicle 3 may be altered as described below.

As illustrated in FIG. 9, an electronic control unit 32 of the vehicle 3 includes an operation support processor 40. Stated another way, an operation support apparatus is mounted on the vehicle 3. The other configuration of the vehicle 3 may not be altered. The operation support processor 40 is configured similarly to the operation support processor 24. An operation support method in the operation support server 2 may be performed in the vehicle 3.

Here, a case is described where the operation support apparatus is mounted on a vehicle 3A. A communication unit 33 of the vehicle 3A may transmit or receive information to or from a communication unit 33 of a vehicle 38. Information may be transmitted or received in communication via a communication network 10 or inter-vehicle communication between the vehicles 3A and 3B. The operation support processor 40 in the vehicle 3A generates second operation information that enables an equivalent operation to be performed in the vehicle 3B from first operation information. The communication unit 33 of the vehicle 3A transmits the second operation information generated by the operation support processor 40 to the vehicle 38. By doing this, the second operation information generated from the first operation information may be obtained in the vehicle 38.

Moreover, a case is described where the operation support apparatus is mounted on the vehicle 3B. The communication unit 33 of the vehicle 3B may transmit or receive information to or from the communication unit 33 of the vehicle 3A. Information may be transmitted or received in communication via the communication network 10 or inter-vehicle communication between the vehicles 3A and 3B. The communication unit 33 of the vehicle 3B obtains first operation information output from the vehicle 3A. The operation support processor 40 of the vehicle 3B generates second operation information from the obtained first operation information. Thus, the second operation information may be obtained in the vehicle 3B.

In addition, a personal information database 34c and an operation information database 34d in a storage unit 34 may respectively store user personal information and operation information of a user in the vehicle 3 that have been stored in a personal information database 23c and an operation information database 23d in the operation support server 2. In this case, the operation support server 2 may be caused to function as a storage unit that receives and stores user personal information and operation information that have been transmitted by each of the vehicles 3.

The electronic control unit 32 of the vehicle 3 includes the operation support processor 40 that is similar to the operation support processor 24, and therefore the same effects may be obtained among the exemplary embodiments. In addition, in the vehicle 3, operation support processing that is similar to the operation support processing of the operation support server 2 may be performed, and this results in a reduction in an amount of data of information that is transmitted or received between the operation support server 2 and the vehicle 3.

Further, after the second operation information of the vehicle 3B is generated from the first operation information of the vehicle 3A in the vehicle 3A, the operation information of the vehicle 3B may be transmitted from the vehicle 3A to the vehicle 3B via the communication network 10 or inter-vehicle communication. Further, in a case where the operation information of the vehicle 3A is transmitted from the vehicle 3A to the vehicle 3B via the communication network 10 or inter-vehicle communication, the operation information of the vehicle 3B may be generated from the operation information of the vehicle 3A in the vehicle 3B. Furthermore, even in a case where a user supplies the operation information of the vehicle 3A to the vehicle 3B by using a recording medium storing the operation information of the vehicle 3A, the operation information of the vehicle 3B may be generated from the operation information of the vehicle 3A in the vehicle 3B. In these cases, it is not necessary to provide a server or the like that performs operation support processing, and this enables a reduction in a cost of the operation support system 1 to be realized.

An operation support program that enables an operation support method to be performed may be recorded in a recording medium that may be read by a computer or another machine or device (hereinafter referred to as a computer or the like). By causing a computer or the like to read and execute a program of this recording medium, the computer functions as the operation support server 2 or the electronic control unit 32 of the vehicle 3. Here, the recording medium that may be read by the computer or the like refers to a non-transitory recording medium that may store information such as data or a program by an electrical, magnetic, optical, mechanical, or chemical action and that may be read by the computer or the like. Examples that may be removed from the computer or the like of the recording medium described above include a flexible disk, a magneto-optical disk, a CD-ROM, a CD-R/W, a DVD, a BD, a DAT, a magnetic tape, a memory card such as a flash memory, and the like. In addition, examples of a recording medium fixed to the computer or the like include a hard disk, a ROM, and the like. Further, an SSD may be used as a recording medium removable from the computer or the like or a recording medium fixed to the computer or the like.

The present disclosure is not limited to the above, and various deformations based on a technical idea may be made. For example, the configuration of the server and the types of information described above are merely examples, and a configuration of the server and types of information that are different from the configuration and the types described above may be employed as needed.

The user terminal device 5 is used to store user personal information, but a recording medium that stores user personal information including operation information, a key including the recording medium, or the like may be used in addition to the user terminal device 5. In this case, the recording medium or the key may be connected to or inserted into a portion that may be read by a recording medium reading device (not illustrated) of the vehicle 3, and various types of information that have been stored may be read. From among the various types of information read from the recording medium, the electronic control unit 32 of the vehicle 3 stores the user personal information in the personal information database 34c, and stores the operation information in the operation information database 34d.

In addition, the reporting of the operation method in step ST16 of the operation support method may be omitted after a predetermined input operation unit that has been determined to need to be reported has been reported a predetermined number of times or in a case where a predetermined time period or more has passed after a user starts driving the vehicle 3B. Stated another way, restrictions may be imposed on the number of times or a time period of the reporting of the operation method in the operation support method. In addition, no restrictions may be imposed on the number of times or a time period of the reporting of the operation method in a case where the application of the vehicle 3B is a rental car or a sharing car, but restrictions may be imposed on the number of times or a time period in a case where the application of the vehicle 3B is a private car or the like.

Moreover, step ST14 is performed in the operation support server 2, but step ST14 may also be performed in the vehicle 3A. Stated another way, after the process of step ST2 is performed in the vehicle 3A so as to count up the number of operations performed on an operated input operation unit, the process of step ST4 may be performed with respect to information relating to an input operation unit for which the number of operations is greater than or equal to a predetermined number. Further, the process of step ST14 may be performed by the operation support processor 24 of the operation support server 2.

The operation information is transmitted or received between the operation support server 2 and the vehicle 3, but the operation information may be transmitted or received between the operation support server 2 and the user terminal device 5. In this case, the reporting of the operation information may be performed by the user terminal device 5.

In a case where a user who has gotten in a first vehicle gets in a second vehicle, second operation information in the second vehicle is output that has been generated from first operation information of the first vehicle of the user, and this enables the user to obtain operation information for performing an operation equivalent to an operation performed on an input unit of the first vehicle in the second vehicle. Therefore, even in a case where the user has changed a vehicle to be gotten in from the first vehicle to the second vehicle, the user may smoothly operate an input unit in the second vehicle.

Moreover, the user may obtain, as second operation information, operation information relating to an input operation unit in the second vehicle that corresponds to an input operation unit having a high frequency of an operation performed by the user in the first vehicle in the first operation information based on the operation performed by the user in the first vehicle. As a result, the user who is in the second vehicle may obtain information relating to an input operation unit that is also likely to have a high frequency of an operation performed by the user in the second vehicle.

Moreover, the user who has changed the vehicle to be gotten in from the first vehicle to the second vehicle may obtain the second operation information in the second vehicle from the report unit at an appropriate timing.

Moreover, it is not necessary to generate the second operation information from the first operation information in the first vehicle and the second vehicle, and therefore a calculation load may be reduced, and the power consumption of a battery may be reduced.

Moreover, after the second operation information is generated from the first operation information in the first vehicle, the second operation information may be transmitted from the first vehicle to the second vehicle via the communication network or inter-vehicle communication. In addition, even in a case where the first operation information is transmitted from the first vehicle to the second vehicle via the communication network or inter-vehicle communication, the second operation information may be generated in the second vehicle. Further, even in a case where the user supplies the first operation information to the second vehicle by using a recording medium storing the first operation information, the second operation information may be generated in the second vehicle. As a result, it is not necessary to provide a server or the like that performs operation support, and this enables a reduction in a cost in an operation support system to be realized.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An operation support apparatus for supporting an operation to be performed on a vehicle, the operation support apparatus comprising
a processor configured to:
obtain first operation information relating to an operation performed by a user in a first vehicle;
generate, from the first operation information, second operation information for performing an operation equivalent to the operation in a second vehicle that is different from the first vehicle; and
output the second operation information.

2. The operation support apparatus according to claim 1, further comprising input devices provided on the first vehicle, wherein
the first operation information includes, for each of the input devices, information relating to an input device for which number of operations performed by the user is greater than or equal to predetermined number of operations or an operation time period is greater than or equal to a predetermined time period, and
the processor is configured to output the second operation information corresponding to the information relating to the input device for which the number of operations performed by the user is greater than or equal to the predetermined number of operations or the operation time period is greater than or equal to the predetermined time period, the information being included in the first operation information.

3. The operation support apparatus according to claim 1, further comprising a report unit provided on the second vehicle and configured to report the second operation information to the user.

4. The operation support apparatus according to claim 3, wherein the report unit is configured to report the second operation information after driving of a drive unit in the second vehicle is started.

5. The operation support apparatus according to claim 3, wherein
the first operation information is associated with traveling history information of the first vehicle, and
the report unit is configured to output the second operation information in a case where traveling of the second vehicle enters into a traveling state close to the traveling history information associated with the first operation information.

6. The operation support apparatus according to claim 1, further comprising:
a transmitter/receiver configured to transmit/receive information between the first vehicle and the second vehicle via a communication network,
wherein the processor is configured to obtain the first operation information from the first vehicle through the transmitter/receiver, and generate the second operation information, and
the transmitter/receiver is configured to transmit the second operation information generated by the processor to the second vehicle.

7. The operation support apparatus according to claim 1, wherein the processor is provided on the first vehicle or the second vehicle.

8. The operation support apparatus according to claim 7, further comprising:
a first transmitter/receiver provided on the first vehicle and configured to transmit/receive information to/from the second vehicle,
wherein the processor is provided on the first vehicle and configured to generate the second operation information, and
the first transmitter/receiver is configured to transmit the second operation information generated by the processor to the second vehicle.

9. The operation support apparatus according to claim 7, further comprising:
a second transmitter/receiver provided on the second vehicle and configured to transmit/receive information to/from the first vehicle,
wherein the second transmitter/receiver is configured to obtain the first operation information that has been output from the first vehicle, and
the processor is provided on the second vehicle and configured to generate the second operation information from the obtained first operation information.

10. A method of supporting an operation to be performed on a vehicle, the method comprising:
obtaining first operation information relating to an operation performed by a user in a first vehicle;
reading the first operation information from a memory;
generating, from the first operation information, second operation information for performing an operation equivalent to the operation in a second vehicle that is different from the first vehicle; and
outputting the second operation information.

11. A non-transitory computer-readable recording medium on which a program for supporting an operation to be performed on a vehicle, the program instructing a processor to execute:
obtaining first operation information relating to an operation performed by a user in a first vehicle;
reading the first operation information from a memory;
generating, from the first operation information, second operation information for performing an operation equivalent to the operation in a second vehicle that is different from the first vehicle; and
outputting the second operation information.
